(19) United States
(12) Patent Application Publication
(10) Pub. No.: US 2017/0121592 A1
(43) Pub. Date: May 4, 2017

(54) METHOD OF MAKING PROPPANTS AND ANTI-FLOWBACK ADDITIVES USING GEAR PELLETIZERS

(71) Applicant: Imerys Oilfield Minerals, Inc., Roswell, GA (US)

(72) Inventors: Johan LORICOURT, Villach (AT); Steffen MOHMEL, Villach (AT)

(21) Appl. No.: 15/318,469

(22) PCT Filed: Jun. 12, 2015
(86) PCT No.: PCT/US2015/035532

§ 371 Date: Dec. 13, 2016

Related U.S. Application Data
(60) Provisional application No. 62/011,877, filed on Jun. 13, 2014.

(51) Int. Cl. C09K 8/80; E21B 43/267; B29C 35/02; C04B 35/64; B29C 47/00

(52) U.S. Cl. CPC C09K 8/80; C04B 35/64; B29C 47/0004; B29C 47/0011; B29C 47/0066; B29C 35/02; E21B 43/267; B29K 2105/16

(57) ABSTRACT

A method of making a proppant may include providing a feed material, extruding the feed material through a nozzle of a rotating body to form a green body, the nozzle being positioned between a plurality of projections and passing from an exterior of the rotating body to a core of the rotating body, and sintering the green body to form the proppant. The method may include drying the green body prior to the sintering. The extruding may be performed using a gear pelletizer. An feed material composition may include a ceramic precursor, a binder, a lubricant, and water. The ceramic precursor may include bauxite. The ceramic precursor may include bauxite and calcium carbonate. The binder may include sodium lignosulfonate. The lubricant may include aluminum stearate, zinc stearate, or oleic acid. The sintered proppants may have a density greater than or equal to about 3.7 g/cm³.

### CLAIM FOR PRIORITY

This PCT International Application claims the benefit of priority of U.S. Provisional Patent Application No. 62/011,877, filed Jun. 13, 2014, the subject matter of which is incorporated herein by reference in its entirety.

### DESCRIPTION

Field of the Disclosure

The present disclosure relates to methods of manufacturing proppants and anti-flowback additives. It also relates to proppants and anti-flowback additives for use in fracturing operations.

Background of the Disclosure

Naturally occurring deposits containing oil and natural gas have been located throughout the world. Given the porous and permeable nature of the subterranean structure, it is possible to bore into the earth and set up a well Where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, companies have employed the well-known technique of fracturing the subterranean area around the well to create more paths for the oil and natural gas to flow toward the well. As described in more detail in the literature, this fracturing is accomplished by hydraulically injecting a fluid at very high pressure into the area surrounding the well bore. This fluid must then be removed from the fracture to the extent possible to ensure that it does not impede the flow of oil or natural gas back to the well bore. Once the fluid is removed, the fractures have a tendency to collapse due to the high compaction pressures experienced at well-depths, which can be more than 20,000 feet. To prevent the fractures from closing, it is well known to include a propping agent, also known as a proppant, in the fracturing fluid. The goal is to be able to remove as much of the injection fluid as possible while leaving the proppant behind to keep the fractures open. The term “proppant,” as used herein, refers to any non-liquid material that is present in a proppant pack and provides structural support in a propped fracture. The term “anti-flowback additive,” as used herein, refers to any material that is present in a proppant pack and reduces the flowback of proppant particles but still allows for production of oil at sufficient rates. The terms “proppant” and “anti-flowback additive” are not necessarily mutually exclusive, so a single particle type may meet both definitions. For example, a particle may provide structural support in a fracture and it may also be shaped to have anti-flowback properties, allowing it to meet both definitions.

The useful life of the well may also be shortened if the proppant particles break down. For this reason, proppants have conventionally been designed to minimize breaking.

The shape of the proppant may have a significant impact on how it packs with other proppant particles and the surrounding area. Thus, the shape of the proppant may significantly alter the permeability and conductivity of a proppant pack in a fracture. Different shapes of the same material offer different strengths and resistance to closure stress. It is desirable to engineer the shape of the proppant to provide high strength and a packing tendency that will increase the flow of oil or natural gas. The optimum shape may differ for different depths, closure stresses, geologies of the surrounding earth, and materials to be extracted.

The conventional wisdom in the industry is that spherical pellets of uniform size are the most effective proppant body shape to maximize the permeability of the fracture. See, e.g., U.S. Pat. No. 6,753,299 to Lunghofer et al. Indeed, the American Petroleum Institute's (“API's”) description of the proppant qualification process has a section dedicated to the evaluation of roundness and sphericity as measured on the Krumbein scale.

Another property that impacts a proppant's utility is how quickly it settles both in the injection fluid and once it is in the fracture. A proppant that quickly settles may not reach the desired propping location in the fracture, resulting in a low level of proppants in the desired fracture locations, such as high or deep enough in the fracture to maximize the presence of the proppant in the pay zone (i.e., the zone in which oil or natural gas flows back to the well). This can reduce the effectiveness of the fracturing operation. Ideally, a proppant disperses equally throughout all portions of the fracture. Gravity works against this ideal, pulling particles toward the bottom of the fracture.

Yet another attribute to consider in designing a proppant is its acid-tolerance, as acids are often used in oil and natural gas wells and may undesirably alter the properties of the proppant. For example, hydrofluoric acid is commonly used to treat oil wells, making a proppant's resistance to that acid of high importance.

Still another property to consider for a proppant is its surface texture. A surface texture that enhances, or at least does not inhibit, the conductivity of the oil or gas through the fractures is desirable. Smoother surfaces may offer certain advantages over rough surfaces, such as reduced tool wear and a better conductivity, but porous surfaces may still be desirable for some applications where a reduced density may be useful.

These properties, some of which can at times conflict with each other, may be weighed in determining the right proppant for a particular situation. In addition, one must also consider the economics of the operation, because stimulation of a well through fracturing is by far the most expensive operation over the life of the well. Proppants are typically used in large quantities, making them a large part of the stimulation cost.

As resources become more scarce, the search for oil and gas involves penetration into deeper geological formations, and the recovery of the raw materials becomes increasingly difficult. Therefore, there may be a desire to provide proppants and anti-flowback additives that have an excellent conductivity and permeability under extreme conditions. In addition, there may be a desire to provide proppants and anti-flowback additives formed from improved or less costly methods and materials that still provide one or more desirable characteristics for propping fractures in modern wells.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

According to one aspect of this disclosure, a method of making a proppant may include providing a feed material, extruding the feed material through a nozzle of a rotating body to form a green body, the nozzle being positioned between a plurality of projections and passing from an exterior of the rotating body to a core of the rotating body, and sintering the green body to form the proppant. According to another aspect, the method may include drying the green body prior to the sintering step.

According to another aspect, the method may include performing the extruding using a gear pelletizer.

According to a further aspect, the sintering may occur at a temperature greater than or equal to about 1300° C., such as, for example, greater than or equal to about 1350° C., greater than or equal to about 1400° C., greater than or equal to about 1450° C., greater than or equal to about 1500° C., greater than or equal to about 1550° C., greater than or equal to about 1600° C., or greater than or equal to about 1650° C. For example, the sintering may occur at a temperature ranging from about 1300° C. to about 1400° C., ranging from about 1350° C. to about 1450° C., ranging from about 1400° C. to about 1500° C., ranging from about 1450° C. to about 1550° C., ranging from about 1500° C. to about 1600° C., or ranging from about 1550° C. to about 1650° C.

According to a further aspect, the sintered proppant may have a density greater than or equal to about 2.5 g/cm³. For example, the sintered proppant may have a density greater than or equal to about 2.55 g/cm³, greater than or equal to about 2.6 g/cm³, greater than or equal to about 2.65 g/cm³, greater than or equal to about 2.7 g/cm³, greater than or equal to about 2.75 g/cm³, greater than or equal to about 2.8 g/cm³, greater than or equal to about 2.9 g/cm³, greater than or equal to about 3.0 g/cm³, greater than or equal to about 3.1 g/cm³, greater than or equal to about 3.2 g/cm³, greater than or equal to about 3.25 g/cm³, greater than or equal to about 3.3 g/cm³, greater than or equal to about 3.4 g/cm³, greater than or equal to about 3.5 g/cm³, greater than or equal to about 3.55 g/cm³, greater than or equal to about 3.60 g/cm³, greater than or equal to about 3.65 g/cm³, greater than or equal to about 3.68 g/cm³, greater than or equal to about 3.69 g/cm³, greater than or equal to about 3.70 g/cm³, greater than or equal to about 3.71 g/cm³, greater than or equal to about 3.72 g/cm³, greater than or equal to about 3.73 g/cm³, greater than or equal to about 3.74 g/cm³, greater than or equal to about 3.75 g/cm³, or greater than or equal to about 3.76 g/cm³.

According to still another aspect, the sintered proppant may have a shrinkage less than or equal to about 24% as compared to the green body, such as, for example, less than or equal to about 12%, less than or equal to about 20%, less than or equal to about 18%, less than or equal to about 17%, less than or equal to about 16% less than or equal to about 15%, less than or equal to about 14%, less than or equal to about 13%, less than or equal to about 12%, or less than or equal to about 11% as compared to the green body.

According to a further aspect, the nozzle may have a multi-foil cross-section, such as, for example, trefoil, quatrefoil, cinquefoil, sexfoil, huitfoil, or higher multi-foil cross-section. According to another aspect, the nozzle may have a regular polygonal cross-section, such as, for example, pentagonal, hexagonal, heptagonal, octagonal, nonagonal, decagonal, or other polygonal cross-section. According to yet another aspect, the nozzle may have a round cross-section, such as, for example, a circular, oval, or elliptical cross-section. According a further aspect, the nozzle may have an irregular or asymmetric cross-section, such as, for example, an egg-shaped cross-section.

According to another aspect, the feed material may include a ceramic precursor, a binder, a lubricant, and water.

According to yet another aspect, the ceramic precursor may include bauxite.

According to still a further aspect, the ceramic precursor may include bauxite and calcium carbonate. According to yet a further aspect, the ceramic precursor may include less than or equal to about 5 wt % of the calcium carbonate.

According to yet another aspect, the ceramic precursor may include kaolin and/or bauxitic kaolin. According to yet another aspect, the ceramic precursor may include a mixture of kaolin, bauxitic kaolin, and/or bauxite.

According to still another aspect, the binder may be selected from the group consisting of methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, phosphates, alginates, and combinations thereof. For example, the binder may include sodium lignosulfonate, calcium lignosulfonate, or monoaluminum phosphate (MAP).

According to yet a further aspect, the lubricant may be selected from the group consisting of stearates, wax emulsions, Manhattan fish oil, stearic acid, wax, palmitic acid, glycerine, linoleic acid, myristic acid, lauric acid, oleic acid, and combinations thereof. According to another aspect, a stearate may include, for example, aluminum stearate or zinc stearate.

According to still a further aspect, the feed material may include a plasticizer. According to another aspect, the plasticizer may be selected from the group consisting of polyethylene glycol, octyl phthalates, ethylene glycol, and combinations thereof.

According to another aspect, the constituent parts of the feed material may be measured in terms of weight percent. The term “weight percent” or “wt %,” as used in this disclosure, refers to the relative weight of a constituent component as compared with the weight of the dry ceramic precursors.

According to another aspect, the feed material may include less than or equal to about 2 wt % of the plasticizer, such as, for example, less than or equal to about 1 wt % or less than or equal to about 0.5 wt % of the plasticizer.

According to a further aspect, the feed material may include less than or equal to about 7 wt % of the binder solution, such as, for example, less than or equal to 6 wt %, less than or equal to 5 wt %, less than or equal to 4 wt %, less than or equal to 3 wt %, less than or equal to 2.5 wt %, less than or equal to 2.25 wt %, or less than or equal to 2 wt % of the binder solution. According to another aspect, the feed material may include from about 1 wt % to about 7 wt % of the binder, such as, for example, from about 2 wt % to about 6 wt %, from about 2.25 wt % to about 5 wt %, from about 3 wt % to about 5 wt %, or from about 4 wt % to about 6 wt % of the binder solution.

According to a further aspect, the feed material may include less than or equal to about 4 wt % of the binder, such as, for example, less than or equal to 3 wt %, less than or equal to 2.5 wt %, less than or equal to 2 wt %, less than or equal to 1.5 wt %, less than or equal to 1.25 wt %, less than or equal to 1.1 wt %, less than or equal to 1 wt %, or less than about 0.5 wt % of the binder. According to another aspect, the feed material may include from about 0.5 wt % to about 3.5 wt % of the binder, such as, for example, from about 0.5 wt % to about 1.5 wt %, from about 1 wt % to about 3 wt %, from about 1.15 wt % to about 2.5 wt %, from about 1.5 wt % to about 2.5 wt %, from about 2% to about 3 wt %, or from about 2.5 wt % to about 2.5 wt % of the binder.

According to another aspect, the feed material may include less than or equal to about 5 wt % of the lubricant, such as, for example, less than or equal to about 4 wt %, less than or equal to about 3 wt %, less than or equal to about 2 wt %, or less than or equal to about 1 wt % of the lubricant. According to another aspect, the feed material may include from about 0.5 wt % to about 5 wt % of the lubricant, such as, for example, from about 0.5 wt % to about 2 wt %, from about 1 wt % to about 4 wt %, from about 2 wt % to about 5 wt %, from about 2 wt % to about 4 wt %, or from about 3 wt % to about 4 wt % of the lubricant.

According to a further aspect, the feed material may include a total water content of less than or equal to about 18 wt %, such as, for example, less than or equal to about 16 wt %, less than or equal to about 15 wt %, less than or equal to about 14 wt %, less than or equal to about 13 wt %, or less than or equal to about 12 wt %. The term “total water content,” as used herein, describes the amount of water present in additive materials (e.g., moisture content of binder solutions or lubricants) plus the amount of water added to the other constituent materials.

According to still another aspect, the feed material may include an added water content of less than or equal to about 16 wt %, such as, for example, less than or equal to about 15 wt %, less than or equal to about 14 wt %, less than or equal to about 13 wt %, less than or equal to about 12 wt % less than or equal to about 11 wt %, less than or equal to about 10 wt %, or less than or equal to about 9 wt %.

Possible advantages of the disclosed embodiments will be set forth in part in the description which follows, or may be learned by practice of the embodiments.

It is to be understood that both the foregoing general description and the following detailed description are exemplary and explanatory only and are not restrictive of the invention, as claimed.

### BRIEF DESCRIPTION OF THE DRAWINGS

FIG. 1 shows a diagram of a portion of an exemplary gear pelletizer.

FIG. 2 shows a portion of an exemplary toothed roll.

FIG. 3 shows an enlarged portion of an exemplary a gear pelletizer.

FIGS. 4A and 4B show microstructures of exemplary proppants.

FIG. 5 shows a length distribution of an exemplary proppant.

### DESCRIPTION OF EXEMPLARY EMBODIMENTS

Reference will now be made in detail to exemplary embodiments of the invention.

According to some embodiments, a method of making a proppant may include providing a feed material, extruding the feed material through a nozzle of a gear pelletizer to form a green body, and sintering the green body to form the proppant. According to another aspect, the method may include drying the green body prior to the sintering step.

According to some embodiments, the sintering may occur at a temperature greater than or equal to about 1300° C., such as, for example, greater than or equal to about 1350° C., greater than or equal to about 1400° C., greater than or equal to about 1450° C., greater than or equal to about 1500° C., greater than or equal to about 1550° C., greater than or equal to about 1600° C., or greater than or equal to about 1650° C. For example, the sintering may occur at a temperature ranging from about 1300° C. to about 1400° C., ranging from about 1350° C. to about 1450° C., ranging from about 1400° C. to about 1500° C., ranging from about 1450° C. to about 1550° C., ranging from about 1500° C. to about 1600° C., or ranging from about 1550° C. to about 1650° C.

The sintering equipment may be any suitable equipment known in the industry, including, for example, rotary or vertical furnaces, or tunnel or pendular sintering equipment.

According to some embodiments, the sintered proppant may have a density greater than or equal to about 3.55 g/cm³. For example, the sintered proppant may have a density greater than or equal to about 3.60 g/cm³, greater than or equal to about 3.65 g/cm³, greater than or equal to about 3.68 g/cm³, greater than or equal to about 3.69 g/cm³, greater than or equal to about 3.70 g/cm³, greater than or equal to about 3.71 g/cm³, greater than or equal to about 3.72 g/cm³, greater than or equal to about 3.73 g/cm³, greater than or equal to about 3.74 g/cm³, greater than or equal to about 3.75 g/cm³, or greater than or equal to about 3.76 g/cm³.

According to some embodiments, the sintered proppant may have a shrinkage less than or equal to about 24% as compared to the green body, such as, for example, less than or equal to about 22%, less than or equal to about 20%, less than or equal to about 18%, less than or equal to about 17%, less than or equal to about 16%, less than or equal to about 15%, less than or equal to about 14%, less than or equal to about 13%, less than or equal to about 12%, or less than or equal to about 11% as compared to the green body.

According to some embodiments, the nozzle may have a multi-foil cross-section, such as, for example, trefoil, quatrefoil, cinquefoil, sexfoil, huitfoil, or higher multi-foil cross-section. According to some embodiments, the nozzle may have a regular polygonal cross-section, such as, for example, pentagonal, hexagonal, heptagonal, octagonal, nonagonal, decagonal, or other polygonal cross-section. According to some embodiments, the nozzle may have a round cross-section, such as, for example, a circular, oval, or elliptical cross-section. According to some embodiments, the nozzle may have an irregular or asymmetric cross-section, such as, for example, an egg-shaped cross-section.

According to some embodiments, the feed material may include a ceramic precursor, a binder, a lubricant, and water.

According to some embodiments, the ceramic precursor may include bauxite.

According to some embodiments, the ceramic precursor may include bauxite and calcium carbonate. According to some embodiments, the ceramic precursor may include less than or equal to about 5 wt % of the calcium carbonate.

According to yet another aspect, the ceramic precursor may include kaolin and/or bauxitic kaolin. According to yet another aspect, the ceramic precursor may include a mixture of kaolin, bauxitic kaolin, and/or bauxite.

According to some embodiments, the ceramic precursor material may include titanium dioxide (TiO₂). The inclusion of TiO₂ may result in the formation of an aluminum titanate phase upon sintering, based on a complex formed by the TiO₂ and alumina (Al₂O₃) in a ceramic precursor. The TiO₂ may be added from non-bauxitic sources, or may be present as part of the bauxite. When TiO₂ and Al₂O₃ are present, sintering at a temperature ranging from about 1300° C. to about 1500° C. may facilitate the formation of an aluminum titanate phase.

According to some embodiments, the amount of Al₂O₃ is greater than or equal to about 58 wt % of the ceramic precursor, such as, for example, greater than or equal to about 70 wt %, greater than or equal to about 75 wt %, greater than or equal to about 80 t %, greater than or equal to about 85 wt %, greater than or equal to about 90 wt %, greater than or equal to about 92 wt %, greater than or equal to about 94 wt %, greater than or equal to about 95 wt %, greater than or equal to about 96 wt %, greater than or equal to about 97 wt %, or greater than or equal to about 98 wt %.

According to some other embodiments, the amount of Al₂O₃ is greater than or equal to about 38 wt % of the ceramic precursor, such as, for example, from about 40 to about 50 wt %, from about 42 to about 45 wt %, from about 45 to about 48 wt %, or from about 45 to about 50 wt %.

According to some embodiments, the amount of iron oxide (Fe₂O₃) is less than or equal to about 12 wt %, such as, for example, less than or equal to about 10 wt %, less than or equal to about 5 wt %, less than or equal to about 2 wt %, less than or equal to about 1.35 wt %, less than or equal to about 1.2 wt %, less than or equal to about 1 wt % or less than or equal to about 0.8 wt %.

According to some embodiments, the binder may be selected from the group consisting of methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, phosphates, alginates, and combinations thereof. For example, the binder may include sodium lignosulfonate, calcium lignosulfonate, or monoaluminum phosphate (MAP).

According to some embodiments, the lubricant may be selected from the group consisting of stearates, wax emulsions, Manhattan fish oil, stearic acid, wax, palmitic acid, glycerine, linoleic acid, myristic acid, lauric acid, oleic acid, and combinations thereof. According to some embodiments, the stearate may include aluminum stearate or zinc stearate.

According to some embodiments, the feed material may include a plasticizer. For example, the plasticizer may be selected from the group consisting of polyethylene glycol, octyl phthalates, ethylene glycol, and combinations thereof.

According to some embodiments, the feed material may include less than or equal to about 2 wt % of the plasticizer, such as, for example, less than or equal to about 1 wt % or less than or equal to about 0.5 wt % of the plasticizer.

According to some embodiments, the feed material may include less than or equal to about 7 wt % of the binder solution, such as, for example, less than or equal to 6 wt %, less than or equal to 5 wt %, less than or equal to 4 wt %, less than or equal to 3 wt %, less than or equal to 2.5 wt %, less than or equal to 2.25 wt %, or less than or equal to 2 wt % of the binder solution. According to some embodiments, the feed material may include from about 1 wt % to about 7 wt % of the binder, such as, for example, from about 2 wt % to about 6 wt % from about 2.25 wt % to about 5 wt %, from about 3 wt % to about 5 wt %, or from about 4 wt % to about 6 wt % of the binder solution.

According to some embodiments, the feed material may include less than or equal to about 4 wt % of the binder, such as, for example, less than or equal to 3 wt %, less than or equal to 2.5 wt %, less than or equal to 2 wt %, less than or equal to 1.5 wt %, less than or equal to 1.25 wt %, less than or equal to 1.1 wt %, less than or equal to 1 wt %, or less than about 0.5 wt % of the binder. According to some embodiments, the feed material may include from about 0.5 wt % to about 3.5 wt % of the binder, such as, for example, from about 0.5 wt % to about 1.5 wt %, from about 1 wt % to about 3 wt %, from about 1.15 wt % to about 2.5 wt %, from about 1.5 wt % to about 2.5 wt %, from about 2 wt % to about 3 or from about 2.5 wt % to about 2.5 wt % of the binder.

According to some embodiments, the feed material may include less than or equal to about 5 wt % of the lubricant, such as, for example, less than or equal to about 4 wt %, less than or equal to about 3 wt %, less than or equal to about 2 wt %, or less than or equal to about 1 wt % of the lubricant. According to some embodiments, the feed material may include from about 1 wt % to about 5 wt % of the lubricant, such as, for example, from about 1 wt % to about 4 wt %, from about 2 wt % to about 5 wt %, from about 2 wt % to about 4 wt % or from about 3 wt % to about 4 wt % of the lubricant.

According to some embodiments, the feed material may include a total water content less than or equal to about 22 wt %, such as, for example, less than or equal to about 20 wt %, less than or equal to about 18 wt %, less than or equal to about 16 wt %, less than or equal to about 15 wt %, less than or equal to about 14 wt %, less than or equal to about 13 wt %, or less than or equal to about 12 wt %.

According to some embodiments, the feed material may include an added water content less than or equal to about 16 wt %, such as, for example, less than or equal to about 15 wt %, less than or equal to about 14 wt %, less than or equal to about 13 wt %, less than or equal to about 12 wt %, less than or equal to about 11 wt %, less than or equal to about 10 wt %, or less than or equal to about 9 wt %.

According to some embodiments, the sintered proppant may have a density greater than or equal to about 2.5 g/cm³. For example, the sintered proppant may have a density greater than or equal to about 2.55 g/cm³, greater than or equal to about 2.6 g/cm³, greater than or equal to about 2.65 g/cm³, greater than or equal to about 2.7 g/cm³, greater than or equal to about 2.75 g/cm³, greater than or equal to about 2.8 g/cm³, greater than or equal to about 2.9 g/cm³, greater than or equal to about 3.0 g/cm³, greater than or equal to about 3.1 g/cm³, greater than or equal to about 3.2 g/cm³, greater than or equal to about 3.25 g/cm³, greater than or equal to about 3.3 g/cm³, greater than or equal to about 3.4 g/cm³, greater than or equal to about 3.5 g/cm³, greater than or equal to about 3.55 g/cm³, greater than or equal to about 3.60 g/cm³, greater than or equal to about 3.65 g/cm³, greater than or equal to about 3.68 g/cm³, greater than or equal to about 3.69 g/cm³, greater than or equal to about 3.70 g/cm³, greater than or equal to about 3.71 g/cm³, greater than or equal to about 3.72 g/cm³, greater than or equal to about 3.73 g/cm³, greater than or equal to about 3.74 g/cm³, greater than or equal to about 3.75 g/cm³, or greater than or equal to about 3.76 g/cm³.

Proppants have previously been manufactured by conventional extrusion methods, such as by extruding a feed material using a die or ram and an extrusion head. Conventional extrusion may have some disadvantages for processing. For example, conventional extrusion feed materials may require a relatively high water content, which increases the amount of time necessary to dry or sinter a green body into a proppant. An increased water content may also lower the density of the green material and the resulting sintered proppant. Furthermore, conventional extrusion tools may have undesirably low throughputs when preparing the green bodies.

Gear pelletization may represent an improvement in proppant manufacturing methods over extrusion techniques. As described in this disclosure, proppants may be manufactured by passing a feed material composition through a gear pelletizer to form a green body. The process may be described as extruding a feed material through a nozzle of a rotating body to form a green body. The nozzle may be positioned between a plurality of projections. During the extrusion, the feed material may pass from an exterior of the rotating body to a core of the rotating body. The green body may be sintered to form a proppant.

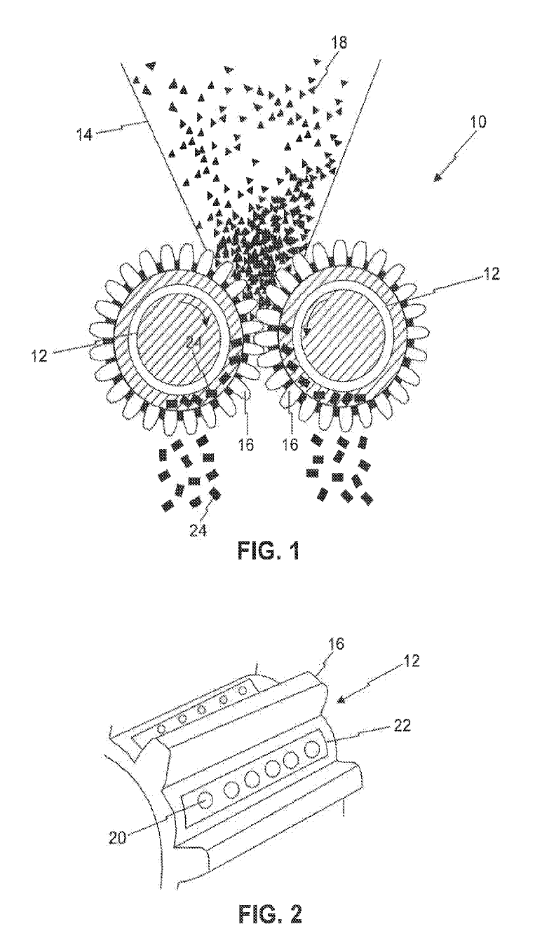

FIG. 1 shows a portion of an exemplary gear pelletizer 10. Gear pelletizer 10 includes toothed rolls 12 and a hopper 14. Toothed rolls 12 may be counter-rotating and have toothed projections 16 that intermesh during rotation of toothed rolls 12. Toothed rolls 12 may have a hollow core (not shown) through which a feed material is pressed by the actions of toothed projections 16. In operation, toothed rolls 12 may be driven may a motor (not shown), which rotates the rolls relative to one another.

Feed material 18 may be a feed material used to form a green body of a proppant. The feed material 18 can be added to hopper 14. Feed material 18 may pass from hopper 14 between the toothed projections 16 of toothed rolls 12. According to some embodiments, an agitator or pressing agent, such as a screw, may be used to force feed material 18 into toothed projections 16. As toothed rolls 12 rotate relative to one another, feed material 18 is forced between and compacted by toothed projections 16.

Toothed rolls 12 may include nozzles 20 between toothed projections 16, as shown in FIG. 2. Nozzles 20 represent cavities or holes that pass from the exterior of toothed rolls 12 to a hollow core of toothed rolls 12. According to some embodiments, nozzles 20 may be part of a die plate 22, which may be insertable into toothed roller 12. According to some embodiments, die plates 22 can be switched to change the geometry of nozzles 20 to facilitate manufacturing of proppants having different cross-sections. For example, in FIG. 2, nozzles 20 are shown with circular cross-sections, any cross-section may be used. For example, according to some embodiments, the cross-section may be a multi-foil cross-section, such as, for example, trefoil, quatrefoil, cinquefoil, sexfoil, huitfoil, or higher multi-foil cross-section. According to some embodiments, the cross-section may be a regular polygonal cross-section, such as, for example, pentagonal, hexagonal, heptagonal, octagonal, nonagonal, decagonal, or other polygonal-shaped cross-section. According to some embodiments, the cross-section may be a rounded cross-section, such as, for example, an oval or elliptical cross-section. According to some embodiments, the cross-section may be an irregular or asymmetric cross-section, such as, for example, an egg-shaped cross-section. According to some embodiments, die plates 22 may have different thicknesses, corresponding to different lengths of nozzles 20.

Without wishing to be bound to a particular theory, it is believed that different geometries (e.g., diameters or lengths) of nozzles 20 may be used to vary the densification of the green bodies produced by the gear pelletizer.

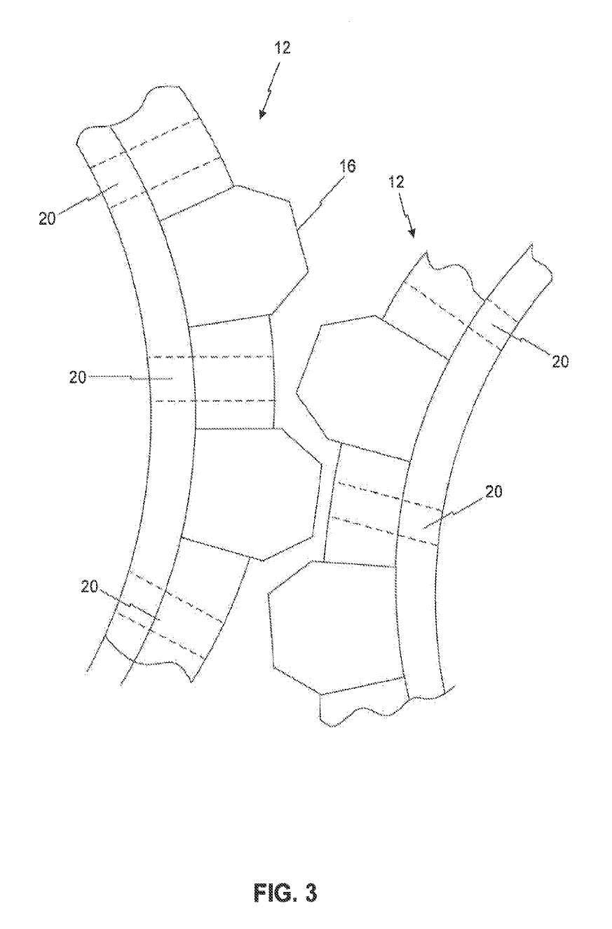

FIG. 3 shows an enlarged portion of gear pelletizer 10 of FIG. 1. As shown in FIG. 3, nozzles 20 pass from the exterior of toothed rolls 12 to the hollow core. As toothed rolls 12 rotate with respect to one another, feed material 18 is forced between toothed projections 16. As toothed projections 16 intermesh with each other, they compact and densify feed material 18. Compaction and densification forces feed material 18 through nozzle 20, which results in feed material 18 being extruded into the hollow core of toothed roll 12 to form pellets 24 (see FIG. 1). According to some embodiments, the densification of feed material 18 may be determined by the diameter and length of nozzle 20. The term “diameter,” as used herein with respect to nozzles 20, does not necessarily indicate that the proppant particles have a circular cross-section. Rather, although “diameter” may be used to described a circular-shaped cross-section, it may also be used to describe cross-sections similar to a circular cross-section, and wherein the “diameter” represents a circle within which the cross-section closely fits (i.e., an enclosing diameter).

Although in FIG. 3, nozzle 20 is shown extending as the same length as the thickness of toothed roll 12, it is contemplated that nozzle 20 may have a length less than or greater than the thickness of toothed roll 12. For example, if nozzles 20 are part of a die plate 22 (not shown), the die plate may have a thickness greater than or less than the thickness of toothed roll 12. According to some embodiments, cutting devices may be installed as part of gear pelletizer 10 to facilitate cutting of the green bodies extruded into the hollow core of toothed rolls 12. A cutting device may include, for example, a blade, knife, or cutting wire.

As the green bodies pass into the hollow core of toothed rolls 12, they form pellets 24, as shown in FIG. 1. Pellets 24 represent a green body of a proppant that may be sintered to create a proppant material.

### Examples

Exemplary feed materials were prepared by mixing a ceramic precursor, a binder, a lubricant, and water. The ceramic precursor included bauxite with 3.7 wt % calcium carbonate. Table 1 shows the exemplary composition based on X-ray fluorescence (XRF) analysis of the bauxite used in this example.

TABLE 1

| Al₂O₃ | SiO₂ | Fe₂O₃ | TiO₂ | K₂O | CaO | LOI |
|---|---|---|---|---|---|---|
| 77.88 | 2.66 | 11.83 | 7.19 | 0.10 | 0.05 | 0.3 |

The ceramic precursor, binder, lubricant, and water were mixed using an Eirich mixer RV02-E having a star-shaped impeller. The dry powder of ceramic precursors (bauxite and calcium carbonate) were first mixed for 60 seconds at 525 rpm. The water and binder was added, and the resulting composition was mixed between 90 and 120 seconds at 1400 rpm. The lubricant was added and the composition was mixed for 30 seconds at 1400 rpm.

The binder in this example was sodium lignosulfonate solution, such as the sodium lignosulfonate commercially available as Borresperse NA from Borregaard LignoTech of Sarpsborg, Norway. The lubricant in this example was oleic acid.

The additive content of the samples represents the amount of binder in the binder solution and the amount of oil. The binder solution used had about 54 wt % moisture. The total water content of the samples represents the amount of added water plus the amount of moisture from the additives (e.g., from the binder solution).

Table 2 shows exemplary feed material compositions that included from 2.25 wt % to 5 wt % binder solution and 1 wt % to 4 wt % lubricant. Because the binder solution contains about 54% moisture, the amount of binder ranged from about 1.1 wt % to about 2.5 wt %

Sample proppants were prepared from the compositions shown in Table Table 2 using a gear pelletizer commercially available from Bepex-Hosokawa. Table 2 also shows exemplary processing parameters using the gear pelletizer. The feed material was loaded into the hopper of the gear pelletizer, which was then operated at various speeds and pressures. The speed is measured in arbitrary units of the gear pelletizer and represents the rotational speed of the toothed rolls. The ampere value is an indication of the pressure exerted on the feed material as it is compressed by the toothed rolls and passes through the nozzles. It is generally preferred to have an ampere value less than 8 for the gear pelletizer used in this example due to machine limitations. The nozzles had a circular cross-section with a diameter of 1.5 mm and a length of 3.95 mm.

TABLE 2

| | Binder | | Additive | Added | | Water + | | |
|---|---|---|---|---|---|---|---|---|
| | solution | Lubricant | content | Water | Total Water | Additives | Speed | |
| Sample | (wt %) | (wt %) | (wt %) | (wt %) | (wt %) | (wt %) | (arbitrary units) | Ampere |
| Sample | 2.25 | 1 | 2.0 | 14.44 | 15.7 | 17.7 | 6 | 7 |
| 6 | | | | | | | | |
| Sample | 2.25 | 2 | 3.0 | 14.44 | 15.7 | 18.7 | 10 | 7 |
| 7 | | | | | | | | |
| Sample | 2.25 | 2 | 3.0 | 13.24 | 14.5 | 17.5 | 5 | 7 |
| 8 | | | | | | | | |
| Sample | 2.25 | 4 | 5.0 | 10.4 | 11.6 | 16.7 | 5 | 8 |
| 11 | | | | | | | | |
| Sample | 2.25 | 4 | 5.0 | 12.7 | 13.9 | 19.0 | 10 | 8 |
| 12 | | | | | | | | |
| Sample | 3.5 | 2 | 3.6 | 12.2 | 14.1 | 17.7 | 3 | 7 |
| 13 | | | | | | | | |
| Sample | 3.5 | 2 | 3.6 | 12.8 | 14.7 | 18.3 | 7 | 7 |
| 14 | | | | | | | | |
| Sample | 5 | 2 | 4.3 | 11.1 | 13.8 | 18.1 | 5 | 7 |
| 15 | | | | | | | | |
| Sample | 5 | 3 | 5.3 | 9.63 | 12.3 | 17.6 | 5 | 8 |
| 16 | | | | | | | | |

As shown in Table 2, increasing the amount of binder and lubricant allows the amount of total water in the feed material to be reduced from about 17 wt % to about 12 wt %. Without wishing to be bound to a particular theory, it is believed that this reduction in water is due to the wettability of the sodium lignosulfonate and the addition of the lubricant to ease the feed material through the nozzles of the gear pelletizer. In general, a higher speed may be preferred because it provides a greater throughput of the feed material. This may increase the amount of proppant that can be manufactured in a given time period. For the gear pelletizer used in this Example, it is preferred that the ampere value not exceed 8 because of machine limitations.

A comparison of samples 6 and 7, which include the same water content, and samples 15 and 16, which include equivalent operating conditions, shows that adding lubricant can result in either an increase in the processing speed (e.g., from sample 6 to sample 7) or a decrease in the water content (e.g., from sample 15 to sample 16). An increase in the speed of processing may allow for more of the proppant green bodies to be produced in a given period of time. A decrease in the water content may shorten the amount of time needed to dry the green bodies to form a sintered proppant. By decreasing the drying time, or the time of other heat treatments, the overall cost of producing the proppant may be reduced.

A comparison of samples 8 and 15, which included the same operating conditions (e.g., speed and ampere value) shows that increasing the amount of binder may allow for less water to be used in the feed material. A comparison of samples 8 and 14, which included the same water content, shows that increasing the amount of binder may also allow for increasing the processing speed. Thus, increasing the amount of binder in the feed material may have similar benefits as increasing the amount of lubricant in some embodiments.

Based on the exemplary data in Table 2, Applicant has surprisingly found that the process of creating the proppants using a gear pelletizer allows for processing with about 10% to about 35% less water than conventional extrusions methods. The lower amount of water may allow for decreased drying time and lower production costs. Furthermore, the water and organic additives used in preparing samples 6-8 and 11-16 was about 1 to about 34 wt % lower as compared to traditional extrusion compositions.

In general, the production rate of the green bodies for the proppants in Table 2 was estimated to be range from about 250 to about 350 kg/h.

Characterizations

After the green bodies were prepared as described in Examples above, the samples were dried at 65° C. for 12 hours. Dried samples were then sintered at 1400° C. for 1 hour in a furnace.

The density of the sintered proppants from samples 6-8, 12, and 16 was measured using the pycnometer method. Table 3 shows the density of the sintered proppants.

TABLE 3

| Reference | Density (g/cm³) |
|---|---|
| Sample 6 (sodium lignosulfonate + oleic acid) | 3.73 |
| Sample 7 (sodium lignosulfonate + oleic acid) | 3.72 |
| Sample 8 (sodium lignosulfonate + oleic acid) | 3.74 |
| Sample 12 (sodium lignosulfonate + oleic acid) | 3.76 |
| Sample 16 (sodium lignosulfonate + oleic acid) | 3.72 |

As shown in Table 3, the density of the sintered proppants prepared using the gear pelletizer was greater than or equal to about 3.7 g/cm³. As a comparison, sintered proppants prepared by conventional extrusion with similar compositions to Table 3 (e.g., bauxite and about 4 wt % calcium carbonate) had lower densities that ranged from about 3.65 g/cm³ to about 3.68 g/cm³.

Table 3 shows that the exemplary processing method can be used to produce sintered proppants having higher densities than conventional extruded proppants with similar compositions. Without wishing to be bound to a particular theory, it is believed that the processing method using a gear pelletizer, a lower water content, or both, may result in the increased densification of the exemplary sintered proppants.

The shrinkage of the proppants for samples 8, 12, and 16 was also estimated based on the diameters of the proppants before and after sintering. The measured diameters of different samples of the sintered proppant rods are shown in Table 4 below. Table 5 shows the average diameter of the sintered proppants and the calculated shrinkage.

TABLE 4
Diameter (mm)

| Sample 8 | Sample 12 | Sample 16 |
|---|---|---|
| 1.25 | 1.22 | 1.25 |
| 1.21 | 1.24 | 1.27 |
| 1.28 | 1.26 | 1.24 |
| 1.28 | 1.27 | 1.24 |
| 1.24 | 1.26 | 1.24 |
| 1.26 | 1.28 | 1.27 |
| 1.23 | 1.23 | 1.25 |
| 1.19 | 1.25 | 1.25 |
| 1.24 | 1.29 | 1.26 |
| 1.21 | 1.28 | 1.24 |

TABLE 5

| | Sample 8 | Sample 12 | Sample 16 |
|---|---|---|---|
| Average diameter (mm) | 1.24 | 1.26 | 1.25 |
| Shrinkage (%) | 17.4 | 16.1 | 16.6 |

As shown in Table 5, the average shrinkage of the exemplary proppants ranged from about 16% to about 17.5%. This shrinkage rate is lower than similar proppants prepared by traditional extrusion methods, which is about 18% to 30%. The lower shrinkage rate of the Examples appears to be consistent with the increased density of the sample proppants. The lower shrinkage rate may also be due to better densification of the green bodies during formation.

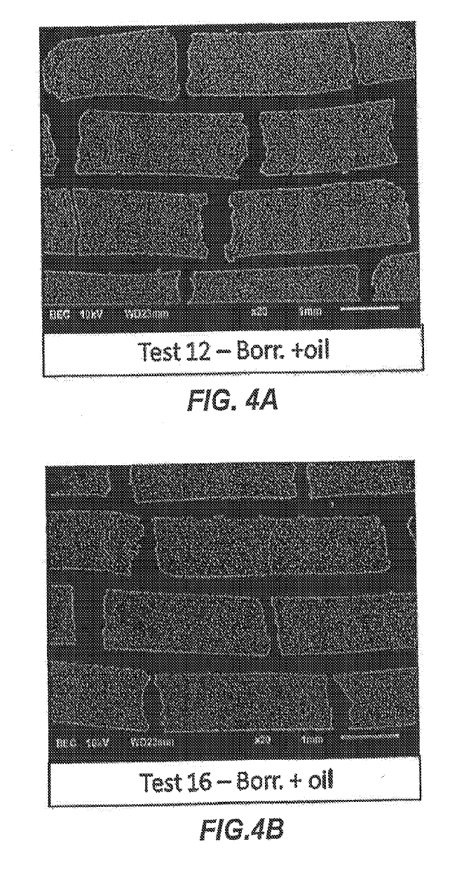

The microstructures of the green-body proppants from samples 12 and 16 were examined using scanning electron microscopy (SEM). FIGS. 4A and 4B show images of the proppants from these samples. As shown in FIGS. 4A and 4B, each of the compositions includes some cracks perpendicular to the extrusion or compaction direction. Without wishing to be bound to a particular theory, it is believed that these cracks perpendicular to the extrusion direction may be explained by delamination of the feed material during compaction, the bending effect of the rods after cutting due to a lack of plasticity, or both. In some cases, such as, for example, sample 12 in FIG. 4A, cracks are also visible parallel to the extrusion direction.

Although the green-body proppants include cracks in the microstructure, this can be mitigated through the addition of a plasticizer, such as, for example, polyethylene glycol or ethylene glycol, to the feed material. According to some embodiments, the amount of plasticizer may be less than or equal to about 1 wt % of the plasticizer.

Crush tests were also performed on sintered samples 12 and 16. The crush test method was similar to the ISO standard, except the ramp-up speed. The test method used a 2-inch diameter pressure cell with a ramp up speed of 4285 psi/min and a dwell time of about 120 seconds. The quantity of fines from the crush test was determined for each of samples 12 and 16. The results from the crush tests are shown in Table 6 below.

TABLE 6

| | Sample 12 | Sample 16 |
|---|---|---|
| Fine Particles (%) | 21.9 | 15.5 |

As shown in Table 6, the fine particles from the crush tests from each of samples 12 and 16 were less than 22 wt %, specifically from about 15% to about 22%. These results are comparable to, and in some cases less than, the percent of fines for similar compositions prepared by conventional extrusion methods, which varies from about 16-20 wt %.

The length distribution of the sintered proppants was also determined. In general, the length of the proppants correlated to the rotation speed of the toothed rolls of the gear pelletizer. When the rotation speed was increased, the length of the proppants was shorter. Conversely, as the rotation speed decreased, the length of the proppants was longer.

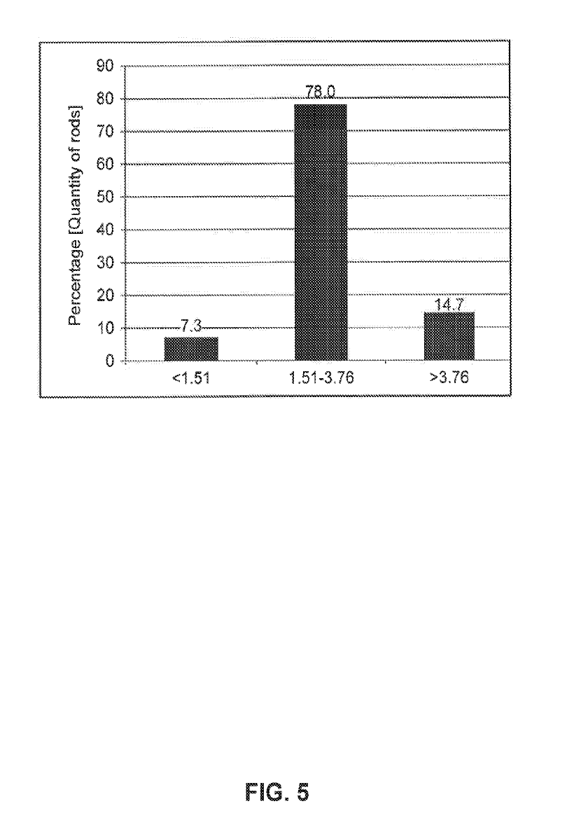

FIG. 5 shows the length distribution of the proppants of sample 8, which was determined without sieving or selection of the sintered proppants. As shown in FIG. 5, about 78% of the proppants have a length greater than 1.51 mm and less than 3.76 mm. About 7.3% of the proppants have a length less than 1.51 mm, and about 14.7% of the proppants have a length greater than about 3.76 mm. The average length of the proppants was about 2.8 mm.

Without wishing to be bound to a particular theory, it is believed that about 5% of the proppants having a length less than 1 mm may due to fragilities in the rods, resulting in breaking of the rods.

As shown above in the Examples and the various characterizations, proppants prepared by a gear pelletization method may have increased densities and improved mechanical properties when compared to conventional extrusion methods. Proppants prepared using a gear pelletization method may also have processing improvements over conventional extrusion methods, such as the use of less water in the green body, which may result, for example, decreased drying time and may also reduce the production cost of the material. The gear pelletization method may also have increased production rates when compared to conventional extrusion methods. The use of sodium lignosulfonate as a binder and oleic acid as a lubricant may allow for a decreased amount of water needed to prepare the proppants.

According to some embodiments, fine particles from a gear pelletizer may be recycled into the feed material. Recycling fine particles back into the feed material may decrease the density of the sintered proppants, but may also increase the strength.

According to some embodiments, starch may be added to the feed material, which may reduce the friability of the pellets, but may also decrease the sintered density.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of making a proppant, the method comprising:
providing a feed material;
extruding the feed material through a nozzle of a rotating body to form a green body, the nozzle being positioned between a plurality of projections and passing from an exterior of the rotating body to a core of the rotating body; and
sintering the green body to form the proppant.

2. The method of claim 1, further comprising drying the green body prior to the sintering.

3. The method of claim 1, wherein the extruding is performed using a gear pelletizer.

4. The method of claim 1, wherein the sintered proppant has a density greater than or equal to about 3.7 g/cm³.

5. (canceled)

6. The method of claim 1, wherein the sintered proppant has a shrinkage less than or equal to about 18%.

7. (canceled)

8. The method of claim 1, wherein the feed material comprises:
a ceramic precursor;
a binder;
a lubricant; and
water.

9. The method of claim 8, wherein the ceramic precursor comprises bauxite.

10. The method of claim 8, wherein the ceramic precursor comprises bauxite and calcium carbonate.

11. The method of claim 10, wherein the ceramic precursor comprises less than or equal to about 5 wt % calcium carbonate.

12. The method of claim 8, wherein the binder is selected from the group consisting of methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulfonates, phosphates, alginates, and combinations thereof.

13. The method of claim 8, wherein the binder comprises sodium lignosulfonate.

14. The method of claim 8, wherein the binder comprises monoaluminum phosphate.

15. The method of claim 8, wherein the lubricant is selected from the group consisting of stearates, wax emulsions, oleic acid, Manhattan fish oil, stearic acid, wax, palmitic acid, glycerine, linoleic acid, myristic acid, auric acid, oleic acid, and combinations thereof.

16. The method of claim 8, wherein the lubricant comprises at least one of aluminum stearate, zinc stearate, or oleic acid.

17. The method of claim 8, wherein the feed material further comprises a plasticizer.

18. The method of claim 17, wherein the plasticizer is selected from the group consisting of polyethylene glycol, octyl phthalates, ethylene glycol, and combinations thereof.

19. The method claim 17, wherein the plasticizer comprises less than or equal to about 1 wt % of the feed material.

20. The method of claim 8, wherein the binder comprises less than or equal to about 5 wt % of the feed material.

21. The method of claim 8, wherein the lubricant comprises less than or equal to about 5 wt % of the feed material.

22. The method of claim 8, wherein the water comprises a total water content of less than or equal to about 18 wt % of the feed material.

23.-43. (canceled)
